(19) United States
(12) Patent Application Publication
(10) Pub. No.: US 2023/0365445 A1
(43) Pub. Date: Nov. 16, 2023

(54) SIDE STREAM FILTER FLUID TREATMENT FOR NEW AND OLD SYSTEMS

(71) Applicant: Building Services Products Ltd., Cleveland (GB)

(72) Inventor: Richard Antony Cowley, Western Cape (ZA)

(21) Appl. No.: 18/246,168

(22) PCT Filed: Sep. 17, 2021
(86) PCT No.: PCT/GB2021/052418

§ 371 Date: Mar. 21, 2023

(30) Foreign Application Priority Data
Sep. 21, 2020 (GB) 2014832.6

(51) Int. Cl. C02F 1/48; C02F 1/00; C02F 1/20; C02F 1/52; B03C 1/28; B01D 21/00; B01D 21/01; F24D 19/08

(52) U.S. Cl. CPC C02F 1/481; C02F 1/004; C02F 1/20; C02F 1/5236; B03C 1/286; B03C 1/284; B01D 21/0009; B01D 21/0012; B01D 21/01; B01D 21/0042; F24D 19/082; C02F 2101/203

(57) ABSTRACT

Certain examples of the present disclosure relate to apparatuses and methods for treating a fluid, such as water, when initially introduced into an empty fluid circuit (such as a heating and/or cooling system) via a temporary fluid connection 602 from a fluid supply connector 601; and also for treating existing fluid in a fluid circuit of a heating and/or cooling system. Certain examples provide an apparatus 101 comprising a vessel 102 having an open upper end 103 and a removable lid 108. The vessel includes: a circulating fluid inlet port 104 in a side wall 105 thereof, a circulating fluid outlet port 106 in a lower end 107 thereof, and a combined drain and water inlet port 600 in the lower end 107 thereof.

### TECHNOLOGICAL FIELD

Examples of the present disclosure relate to apparatuses (not least such as side stream filters) and methods for fluid treatment. Some examples, though without prejudice to the foregoing, relate to an apparatus and method for treating fluid when initially introduced into an empty fluid circuit (such as a heating and/or cooling system). Some examples, though without prejudice to the foregoing, relate to an apparatus and method for treating existing fluid in a fluid circuit (such as a heating and/or cooling system).

### BACKGROUND

Conventional commercial and domestic heating and/or cooling systems comprise a fluid circuit through which a fluid circulates under pressure. The type of fluid used may be water or a water/anti-freeze mix. Such heating and/or cooling systems are typically of a closed-circuit and kept under pressure.

For example, a typical fluid circuit in a heating system may comprise a pipework loop in which circulating water flows, from a boiler (by means of a mechanical pump), through a series of radiators releasing the heat energy, and then back to the boiler for re-heating.

Dirt, debris, detritus, corrosion debris, sludge and bacteria in the system pipework and circulating fluid of a heating and/or cooling system can adversely effect the system's performance efficiency. Such unwanted material within the system pipework and circulating fluid can cause cold spots at the bottom of radiators and can lead to blockages in: filters, pipework, valves, boiler heat exchanger, and other parts of the system and associated system plant items. This can lead to reduced performance efficiency, fluid leakage, and ultimately resulting in a premature system failure. Bacteria in the system pipework can multiply leading to slime formations that can likewise lead to blockages, reduced performance efficiency, and ultimately resulting in a premature system failure.

Conventional commercial and domestic heating and/or cooling systems are not always optimal.

One issue that conventional closed-circuit type heating and/or cooling systems have relates to an initial filling of the fluid circuit with a fluid. The fluid/fill fluid for filling the fluid circuit is generally sourced from an incoming mains water supply, i.e., from the property in which the heating and/or cooling system is installed and located. It is common practice in the Heating, Ventilation and Air Conditioning (HVAC) industry to connect initial fill fluid pipework, via a temporary pipework connection, to the closed-circuit system pipework via an isolation valve or drain valve.

However, the mains water supply may be contaminated and may harbour bacteria and other microbes and microorganisms. One typical type of water borne bacteria is Pseudomonas (which is widely referenced in the industry, such as by the British Association for Chemical Specialities, BSRIA, within their speciality Guides BG50 2013 [Water treatment for closed heating and cooling systems] and also BG29 2021 [Pre-commissioning cleaning of pipework systems]). Single celled microorganisms such as bacteria in the fluid can aggregate into colonies and can circulate freely in the system water as “planktonic” bacteria or adhere to pipe walls as “sessile” bacteria forming a biofilm layer on pipe surfaces which can lead to Microbially Influenced Corrosion, MIC, of the pipework.

Bacteria, biofilm and resulting slime within the heating and/or cooling fluid can reduce the performance efficiency of the heating and/or cooling system as a whole, cause blockages in pipework, prematurely block a filter of the heating and/or cooling system (rendering the filter inoperable and unable to remove system debris) and can also lead to total system failure.

In some circumstances it can be desirable to provide improved fluid treatment that can reduce bacteria, microbes and microorganisms in the fluid of a fluid circuit of a heating and/or cooling system, and/or reducing bacteria, microbes and microorganisms in initially introduced fill fluid for filling an empty fluid circuit of the heating and/or cooling system.

Moreover, the mains water supply may harbour dirt, debris and detritus, e.g., not least from the mains supply pipework. Such dirt, debris and detritus from the mains supply pipework may be from the mains water pipework corroding (especially from old steel pipework) and the remnants of any soil, sand or organic materials which may have got into the mains supply pipework during remedial works upstream of the closed-circuit system.

Dirt, debris and detritus harboured in the fill fluid, i.e., the water mains supply, that initially fills an empty fluid circuit of a heating and/or cooling system, can reduce the performance efficiency of the heating and/or cooling system as a whole, cause blockages in pipework, prematurely block a filter of the heating and/or cooling system (rendering the filter inoperable and unable to remove system debris) and can also lead to total system failure.

In some circumstances it can be desirable to provide improved fluid treatment that can reduce dirt, debris and detritus in the fluid of a fluid circuit of a heating and/or cooling system, and/or reducing dirt, debris and detritus in initially introduced fill fluid for filling an empty fluid circuit of the heating and/or cooling system.

Yet furthermore, the mains water supply used to fill the fluid circuit of the heating and/or cooling system may contain oxygen, e.g., dissolved oxygen, as well as other dissolved air gasses. The mains water supply used during the filling of the fluid circuit of the heating and/or cooling system contains the largest concentration of dissolved oxygen. It is common practice in the industry to connect the initial fill fluid pipework via a temporary pipework connection to the closed-circuit system pipework via an isolation valve or drain valve.

Dissolved oxygen within the initial fill fluid/mains water enters the heating and/or cooling system and its pipework during the filling process, and the oxygen within the fill fluid can increase a rate of corrosion within the fluid circuit and the metals/pipework found within the heating and/or cooling system as a whole.

In some circumstances it can be desirable to provide improved fluid treatment that can reduce the oxygen content of the fluid of a fluid circuit of a heating and/or cooling system, in particular the initial introduced fill fluid for filling an empty fluid circuit of the heating and/or cooling system.

In some circumstances it can be desirable to provide improved fluid treatment that can de-oxygenate/reduce the oxygen content in the fluid of a fluid circuit of a heating and/or cooling system, and/or reducing the oxygen content in initially introduced fill fluid for filling an empty fluid circuit of the heating and/or cooling system.

The most common sources of contamination or impurities in a circulating fluid (i.e., a fluid circulating in a fluid circuit of the heating and/or cooling system) are physical in nature: corrosion, lime scale and microbiological growths (bacteria and fungi). However, other pollutants can also be also found within the circulating fluid that have been dissolved into the circulating fluid. Such contaminants may have previously been solids but have since been solubilised into the circulating fluid, not least for example dissolved iron. Accordingly, circulating fluid may become contaminated with dissolved solids (e.g., dissolved metals such as from the pipework, valves, heat exchanger, and metallic components that come into contact with the circulating fluid during use). Older heating and/or cooling systems may suffer from corrosion debris within the circulating fluid which may lead to contamination throughout the system. Circulating fluid contaminated with dissolved solids can resulting corrosion of the pipe work, and valves and internal components of the heating and/or cooling system, which can cause a reduction in the performance efficiency of the system and possibly leading to total system failure.

One industry recognised and current way of removing such dissolved solids, such as dissolved iron, from contaminated circulating fluid of a heating and/or cooling system is by way of flushing the system's pipework with new, clean mains supply water.

Flushing clean mains supply water through the system's pipework will dilute the existing contaminated circulating fluid and replenish it with fresh mains water. At the same flow rate the new, clean mains supply water is introduced to the system's pipework whilst the existing (contaminated) circulating fluid of the system is drained from the system's pipework. However, this process uses many times the original system volume of circulating water to achieve a dilution which is an appropriate and acceptable level of cleanliness, e.g., that meets limits required to be within the industry guidelines.

In some circumstances it can be desirable to provide improved fluid treatment that can reduce an amount of dissolved solids in an efficient manner, in particular so as to reduce the quantity of fluid consumption.

As described above, the circulating fluid of a conventional closed-circuit fluid systems (such as heating and/or cooling system) can become contaminated with corrosion debris (rust), lime scale and microbiological growths (bacteria or fungi), resulting in a reduction in the performance efficiency of the heating and/or cooling system and possibly also leading to total system failure.

Fluid treatment devices (which may be known as ‘side stream filters’ or ‘x-pots’) for filtering circulating fluid of a sealed/closed fluid circuit commercial heating and/or cooling system are known for heating or cooling systems. Such fluid treatment devices may comprise a closed vessel that is connectable into the fluid circuit of the system and which allows for the filtering of magnetic and non-magnetic system debris only to take place. The filters of such fluid treatment devices can become blocked over time. Such fluid treatment devices have a single fluid outflow port located in the lower end of the vessel, which is down-stream of the filter, via which the vessel can be drained. Accordingly, since the fluid outflow port is located down-stream of the filter, the draining of the vessel (via the fluid outflow port down-stream of the filter) is not possible when the filter is blocked, i.e., the drain function of such fluid treatment devices is in-operable when the filter is blocked. In normal operation, the blocked filter's location is up-stream of the only vessel drain port, thereby the blocked filter blocks the draining of the vessel via the vessel drain port which is down-stream of the blocked filter. For such filter treatment devices, the internal vessel cavity becomes the focus for the collection of all detritus, bacteria and biofilm within the circulating fluid from the heating and/or cooling system and on the multiple filtration surfaces therein. The vessel and the circulating fluid within are in a pressurised state and full of a concentrated contaminated fluid with detritus and bacteria which can become a health and safety issue for the operator.

In some circumstances it can be desirable to provide improved fluid treatment that addresses one or more of the above-mentioned issues.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any embodiments/examples and features described in this specification that do not fall under the scope of the independent claims are to be interpreted as examples useful for understanding various embodiments of the invention.

According to at least some examples of the disclosure, there is provided an apparatus for treating fluid when initially introduced into an empty fluid circuit via a temporary fluid connection from a fluid supply connector, the apparatus also being suitable for treating existing fluid in a fluid circuit of a heating and/or cooling system, wherein the apparatus comprises a vessel comprising:
an open upper end,
a removable lid,
a circulating fluid inlet port in a side wall of the vessel,
a circulating fluid outlet port in a lower end of the vessel, and
a combined drain and water inlet port in the lower end of the vessel.

According to at least some examples of the disclosure, there is provided an apparatus to treat fluid when initially introduced into an empty fluid circuit via a temporary fluid connection from a fluid supply connector; the apparatus comprising a vessel having:
an open upper end;
a removable lid comprising a dosing port and an air vent port;
a circulating fluid inlet port in a side wall of the vessel;
a circulating fluid outlet port in a lower end of the vessel;
a combined drain and water inlet port in the lower end of the vessel;
a filter removably locatable within the vessel; and
a permanent magnet collector, removably locatable within the vessel.

According to at least some examples of the disclosure, there is provided an apparatus to treat existing fluid in a fluid circuit of a heating and/or cooling system, the apparatus comprising a vessel having:
an open upper end;
a removable lid comprising a dosing port and an air vent port;
a circulating fluid inlet port in a side wall of the vessel;
a circulating fluid outlet port;
a combined drain and water inlet port in a lower end of the vessel;
a filter removably locatable within the vessel; and
a permanent magnet collector, removably locatable within the vessel.

According to various, but not necessarily all, examples of the disclosure there is provided a side stream filter comprising one of the above-mentioned apparatuses.

According to various, but not necessarily all, examples of the disclosure there is provided a heating and/or cooling system comprising one of the above-mentioned apparatuses.

According to various, but not necessarily all, examples of the disclosure there is provided a method of installing one of the above-mentioned apparatuses.

According to various, but not necessarily all, examples of the disclosure there is provided a method of treating fluid using one of the above-mentioned apparatuses.

According to various, but not necessarily all, examples of the disclosure there is provided a method of providing and/or manufacturing an apparatus and/or system as described herein.

According to various, but not necessarily all, examples of the disclosure there is provided a method of using an apparatus and/or system as described herein.

The following portion of this ‘Brief Summary’ section describes various features that can be features of any of the examples described in the foregoing portion of the ‘Brief Summary’ section. The description of a function should additionally be considered to also disclose any means suitable for performing that function.

In some but not necessarily all examples, the removable lid can include a dosing port and an air vent port.

In some but not necessarily all examples, the removable lid can be securable to the vessel by mechanical fixings.

In some but not necessarily all examples, the apparatus can further comprise a permanent magnet collector removably locatable within the vessel.

In some but not necessarily all examples, the permanent magnet collector can be arranged to collect magnetic particles on an external collection surface of the permanent magnet collector.

In some but not necessarily all examples, the permanent magnet collector can be arranged in the form of a grate or another suitable shape for collecting debris.

In some but not necessarily all examples, the permanent magnet collector can comprise a plurality of housings each containing a permanent magnet.

In some but not necessarily all examples, the vessel can comprise a bracket for mounting the vessel to a wall.

In some but not necessarily all examples, the vessel can comprise a filter removably locatable within the vessel.

In some but not necessarily all examples, the removable filter can be configured to collect non-magnetic particles on an external collection surface of the removable filter.

In some but not necessarily all examples, the removable filter can be configured to collect bacteria on an external collection surface of the removable filter.

In some but not necessarily all examples, the vessel can comprise a removable baffle plate.

In some but not necessarily all examples, the vessel can comprise means for regulating a flow of fluid within the vessel, wherein means for regulating a flow of fluid within the vessel is removably locatable within the vessel.

In some but not necessarily all examples, the means for regulating the flow of fluid can comprise at least one magnetic filtering means.

In some but not necessarily all examples, the means for regulating the flow of fluid can comprise at least one housing for housing at least one magnetic member.

In some but not necessarily all examples, the means for regulating the flow of fluid can comprise at least one elongate shaft.

In some but not necessarily all examples, the at least one elongate shaft can comprise a plurality of apertures along a length of the elongate shaft.

In some but not necessarily all examples, the elongate shaft can be configured to be locatable within the circulating fluid outlet.

In some but not necessarily all examples, the vessel can comprise filtering means comprising an aperture therethrough configured to receive the elongate shaft.

In some but not necessarily all examples, the vessel can comprise means for removing dissolved solids from a fluid, wherein the means for removing dissolved metal is removably locatable within the vessel.

In some but not necessarily all examples, the means for removing dissolved solids can comprise a container comprising a filter media configured to remove dissolved metal.

While the above examples of the disclosure and optional features are described separately, it is to be understood that their provision in all possible combinations and permutations is contained within the disclosure. Also, it is to be understood that various examples of the disclosure can comprise any or all of the features described in respect of other examples of the disclosure, and vice versa.

### BRIEF DESCRIPTION OF THE DRAWINGS

Some examples will now be described with reference to the accompanying drawings in which:

FIG. 1 shows a front and side view of an example of an apparatus for use in the treatment of fluid in a fluid circuit of a heating and/or cooling system;

FIG. 2 shows a front and side view of another example of an apparatus for use in the treatment of fluid in a fluid circuit of a heating and/or cooling system;

FIG. 3 shows an example of a permanent magnet collector for use in the fluid treatment apparatuses in accordance with the present disclosure;

FIG. 4 shows a top view and an underside view of an example of a baffle plate for use in the fluid treatment apparatuses in accordance with the present disclosure;

FIG. 5 shows a top view and an underside view of another example of a baffle plate which is a combined baffle with a permanent magnet collector for use in the fluid treatment apparatuses in accordance with the present disclosure;

FIG. 6 shows top, side and underside views of an example of a cartridge type filter for use in the fluid treatment apparatuses in accordance with the present disclosure;

FIG. 7 shows top, side and underside views of another example of a cartridge type filter for use in the fluid filter apparatuses in accordance with the present disclosure;

FIG. 8 shows top, side and underside views of an example of a basket type filter for use in fluid treatment apparatuses in accordance with the present disclosure; and

FIG. 9 shows a schematic diagram of the fluid treatment apparatus of FIG. 1 during an introduction of new fluid to an empty fluid circuit of a heating and/or cooling system;

FIG. 10 shows a schematic diagram of another example of a fluid treatment apparatus during an introduction of new fluid to an empty fluid circuit of a heating and/or cooling system;

FIG. 11 shows a schematic diagram of the fluid treatment apparatus of FIG. 1 during treatment of existing circulating fluid of a fluid circuit of a heating and/or cooling system;

FIG. 12 shows a schematic diagram of the fluid treatment apparatus of FIG. 1 during a process of removing dissolved solids from existing circulating fluid of a fluid circuit of a heating and/or cooling system; and

FIG. 13 shows a schematic diagram of a further example of a fluid treatment apparatus in accordance with the present disclosure.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the drawings (and description) a similar feature may be referenced by the same number.

### DETAILED DESCRIPTION

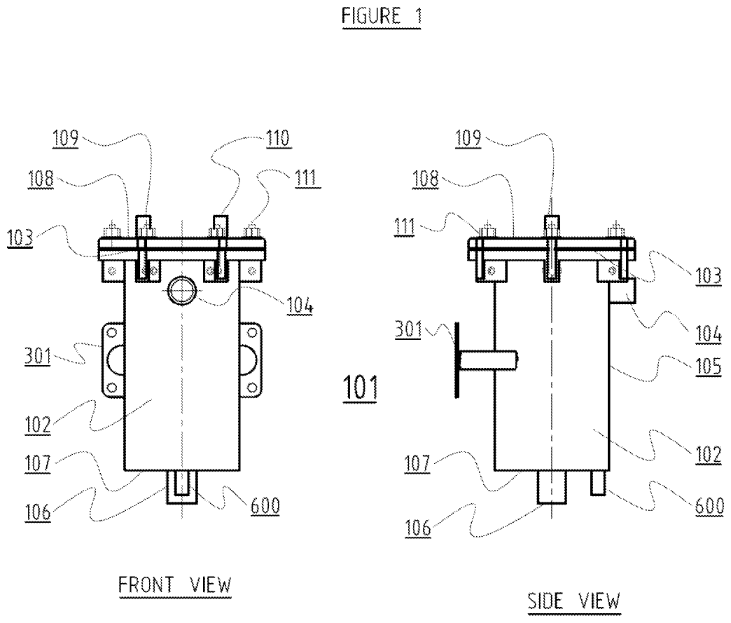

FIG. 1 shows a front and side view of an example of an apparatus 101 for use in the: treatment of new fluid to a fluid circuit of a heating and/or cooling system, pre-treatment of new fluid prior to entering a fluid circuit (e.g., an empty fluid circuit) of a heating and/or cooling system, and treatment of fluid (e.g., existing fluid) in a fluid circuit of a heating and/or cooling system.

The fluid treatment apparatus 101 comprises a vessel 102 that defines an open upper end 103. The vessel 102 comprises a circulating fluid inlet port 104 via which, in use, circulating fluid of the fluid circuit of the heating and/or cooling system enters into the vessel 102. In this example, the circulating fluid inlet port 104 is located in a side wall 105 of the vessel 102. The vessel further comprises a circulating fluid outlet port 106 via which, in use, circulating fluid of the fluid circuit leaves the vessel 102. In this example, the circulating fluid outlet port 106 is located in a lower end 107 of the vessel, namely a bottom wall of the lower end 107. The circulating fluid outlet port 106 may be centrally located in the bottom wall of the lower part and extend in a downwards direction to facilitate the outlet of fluid from the vessel 102.

The vessel 102 also comprises a combined drain and water inlet port 600 which, in this example, is located in the lower end 107 of the vessel, namely the bottom wall of the lower end 107. In this example, the combined drain and water inlet port 600 extends in a downwards direction, which may facilitate the draining of fluid from the vessel 102.

The open upper end 103 of the vessel 102 is provided with a removable lid 108 defining a dosing port 109 and an air vent port 110. In the example shown, the removable lid 108 is secured to the vessel 102 by means of a mechanical fixing 111. Any suitable fixing may be used to releasably secure the removable lid 108 to the vessel 102. In the example shown, a plurality of mechanical fixings 111 is provided for this purpose. In the example shown, there is a bracket 301. One or more brackets may be provided, or support legs provided, for use with larger heavier vessels which require a greater degree of support than smaller and lighter vessels.

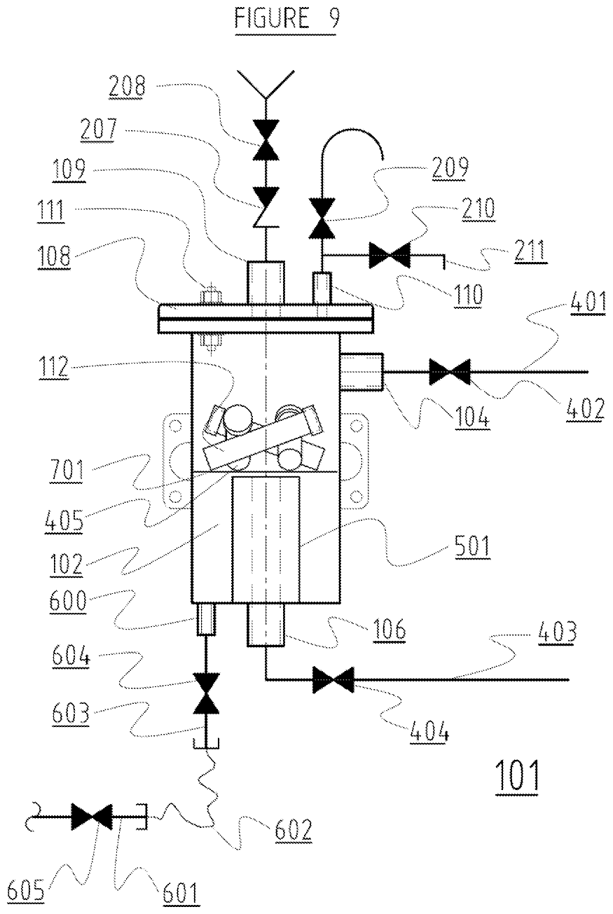

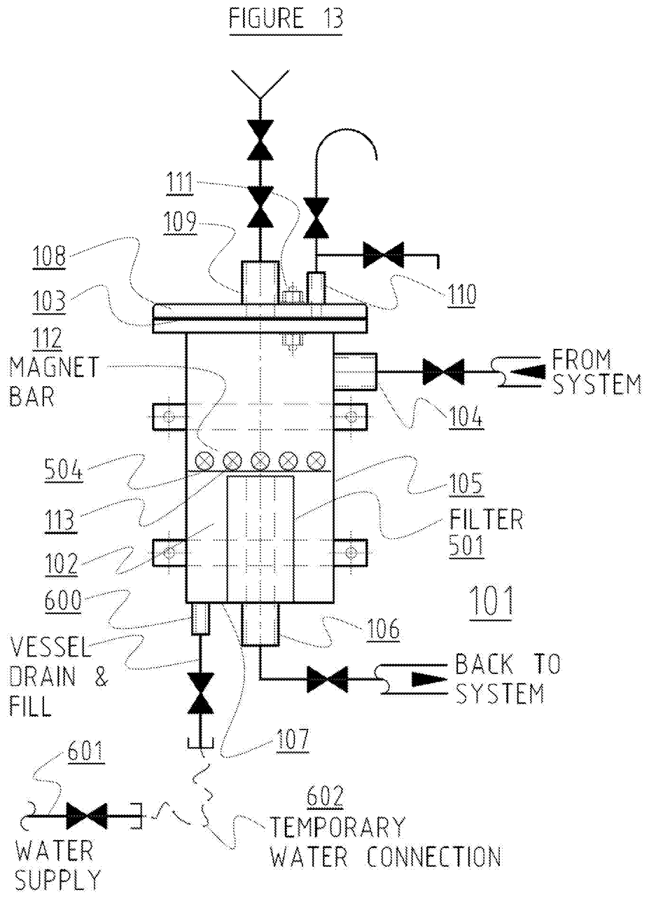

As will be described in further detail, the apparatus 101 is advantageously benefitted by the provision of, in addition to the circulating fluid inlet port 104 and the circulating fluid outlet port 106, a combined drain and water inlet port 600. Advantageously, the combined drain and water inlet port 600 allows a new (i.e., empty/not yet filled with circulating fluid) heating and/or cooling system to be filled with initial filling fluid, i.e., mains water. Moreover, as will be discussed further below (not least with respect to FIGS. 9 and 13), due to the relative locations and arrangements of the combined drain and water inlet port 600, a removable filter 501 of the vessel (not shown) and fluid outlet port 106, water newly introduced into the vessel via the combined drain and water inlet port 600 (to fill the vessel and moreover fill the heating and/or cooling system) must pass through the filter prior to passing out through the fluid outlet port 106 into the heating and/or cooling system and its pipework. Advantageously, the newly introduced water is thereby filtered/pre-treated prior to entering the rest of the heating and/or cooling system. Such pre-treatment may filter out the magnetic and non-magnetic detritus, filter out bacteria (e.g., via an anti-microbial coating on the removable filter 501) the initial filling fluid, i.e., mains water, prior to the mains water leaving the vessel and entering the heating and/or cooling system. The passing of the initial filling fluid through the filter prior to leaving the vessel and entering the heating and/or cooling system also advantageously helps de-oxygenate/de-gas the initial filling fluid, since the filtration media of the filter promotes the formation of micro-bubbles, of oxygen and other gases/air dissolved in the initial filling fluid (i.e., mains water), on the filter. Such micro-bubbles, once formed, coalesce and converge together and, when large enough, rise upwards and can evacuate the vessel 102 via an automatic air vent 209 of the air vent port 110.

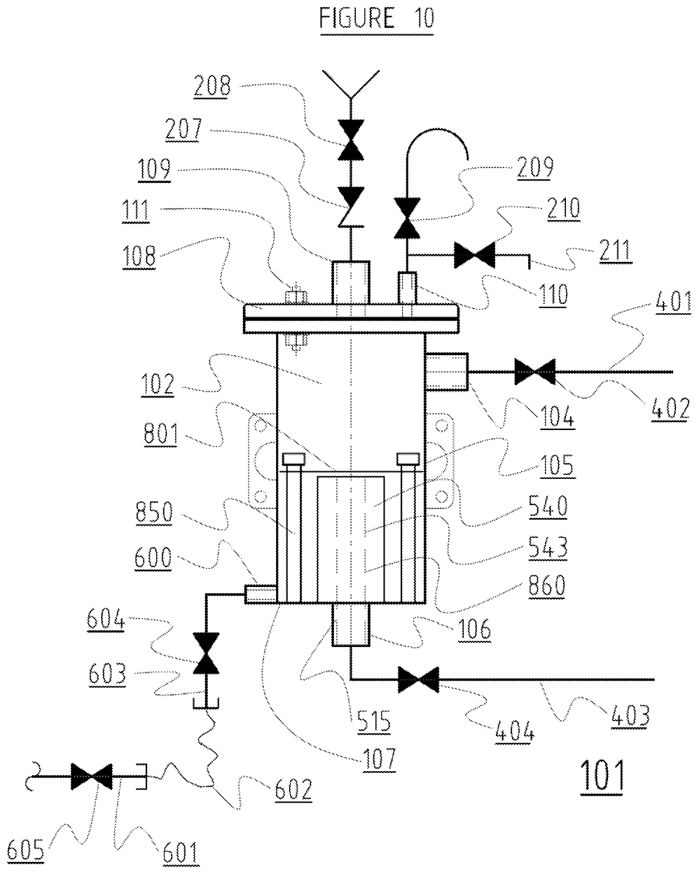

Advantageously, some examples of the fluid treatment apparatus 101 can also provide the further functionality of enabling the draining of a fluid (e.g., contaminated fluid) from the vessel 102 by the use of the combined drain and water inlet port 600. As will be discussed in further detail below (not least with respect to FIGS. 10 and 13), the combined drain and water inlet port 600 located ‘up-stream’ of an external collection surface 113 of the removable filter 501. Hence, when the removable filter 501 is blocked such that (contaminated) fluid cannot pass through the blocked filter and out of the vessel via the circulating fluid outlet port 106, the (contaminated) fluid can be drained out of the vessel via the combined drain and water inlet port 600, thereby enabling safe extraction of a permanent magnet collector 112, a removable baffle plate 504 and the removable filter 501 from the empty vessel.

Some examples of the fluid treatment apparatus 101 may also advantageously reduce/ameliorate/prevent the growth of bacteria and biofilm by using an anti-microbial coating, prevent the growth of bacteria, on the apparatus 101, the removable filter 501 the permanent magnet collector 112, and/or the baffle plate 701.

Some examples of the fluid treatment apparatus 101 may thus provide the filtering and dosing functionality of a conventional/known fluid treatment apparatus and also may beneficially provide the above-described further functionality.

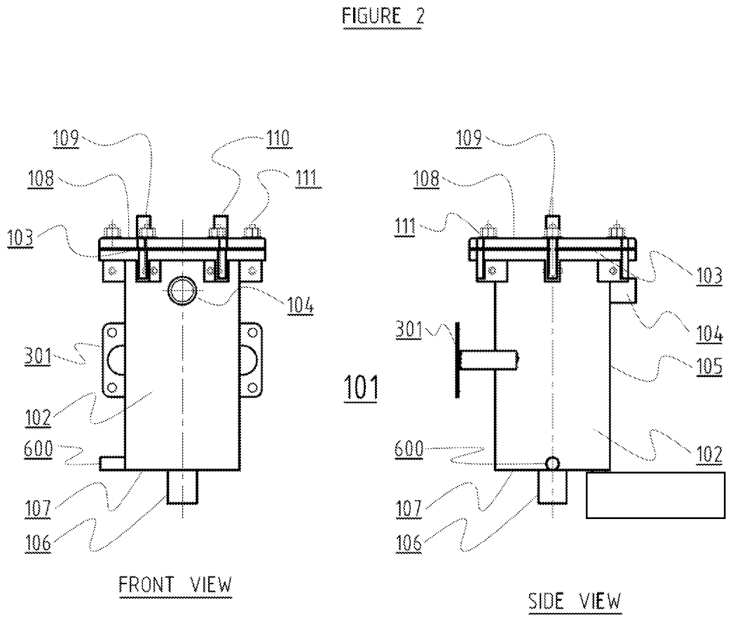

FIG. 2 shows a front and side view of another example of an apparatus for use in the pre-treatment of fluid for a fluid circuit of a heating and cooling system, i.e., the treatment of new fluid/filling fluid newly introduced to the vessel prior to the fluid passing from the vessel into the fluid circuit of the heating and cooling system.

The fluid treatment apparatus of FIG. 2 is substantially similar to that of the fluid treatment apparatus of FIG. 1, with the difference that the combined drain and water inlet port 600 is located in a side wall 105 of the vessel 102. For example, the combined drain and water inlet port 600 is located at the lower end 107 of the vessel 102 in a lower portion of the side wall 105 of the vessel 102 (as opposed to the fluid treatment apparatus of FIG. 1 wherein the combined drain and water inlet port 600 is located at the lower end 107 of the vessel 102 in a bottom wall of the vessel 102). In this example, the combined drain and water inlet port 600 extends in a horizontal direction. Locating the combined drain and water inlet port 600 at the lower end 107 of the vessel 102, i.e., a lower portion of the side wall, may facilitate the draining of fluid from the vessel 102.

Examples of the fluid treatment apparatus of FIG. 2 may thereby provide filtering and dosing functionality of a conventional/known fluid treatment apparatus, but may also beneficially provide the further functionality similar to/the same as provided by the fluid treatment apparatus of FIG. 1.

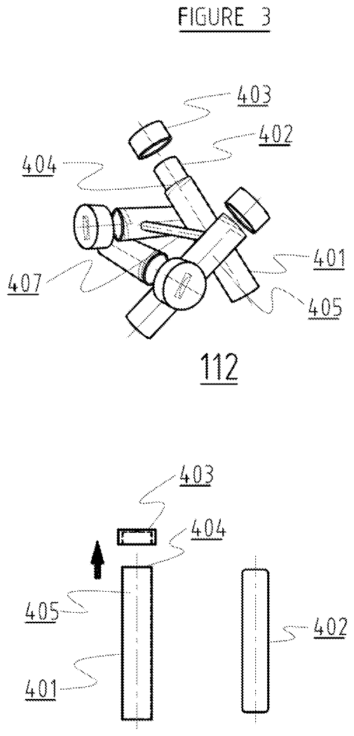

FIG. 3 shows an example of a permanent magnet collector 112 (and a detail thereof) for use with fluid treatment apparatuses of the present disclosure (not least such as those illustrated and described with respect of FIGS. 1, 2 and 13). In use, when the fluid treatment apparatus is installed/connected to a fluid circuit of a heating and/or cooling system, the permanent magnet collector 112 may be removably locatable in a vessel of the fluid treatment apparatus in order to remove metal debris and detritus from circulating fluid of the fluid circuit. The permanent magnet collector 112 serves as a metal filtering means for filtering out magnetic metals (e.g., debris, detritus comprising ferromagnetic metals, not least such as iron) from a fluid.

The permanent magnet collector 112 comprises a plurality of tubular housings 401, each housing a permanent magnet 402.

Optionally, and in the example shown, at least one end 404 of each of the tubular housing is provided with a removable cover 403, to allow the selective removal of the permanent magnet 402 housed therein.

In some examples, the permanent magnet collector 112, has a non-magnetic surface. This beneficially provides for magnetic particles to be collected on an external collection surface 405 of each tubular housing 401 and for them to be removed by the process of removing the permanent magnet 402 from within the tubular housing 401 and allowing the magnetic particles to drop from the (non-magnetic) external collection surface of the tubular housing. Following such a cleaning operation of the permanent magnet collector 112, the permanent magnet can then subsequently be replaced inside the tubular housing.

The tubular housings are arranged relative to one another in the form of an overlapping grate. In the example shown, the grate arrangement comprises 4 singular tubular housings 401 overlapping end over end, which can complement a circular cross-sectional shape of the vessel within which the permanent magnet collector is to be located and used. Optionally, and in the example shown, the tubular housings 401 are connected to each other and by at least one handle 407, which is used to facilitate manual handling of the permanent magnet collector 112 during placement within a vessel and removal from a vessel (e.g., to undergo a cleaning operation).

In some examples, the underside of the permanent magnet collector 112 can be configured to be substantially planar.

In some examples, the permanent magnet collector 112 can comprise an anti-microbial coating to prevent/reduce the growth of bacteria on the permanent magnet collector 112.

It is to be appreciated that any suitable number of tubular housings 401 containing a permanent magnet may be used, in any suitable arrangement. The dimensions and shape of tubular housings may also vary between applications. Components of the permanent magnet collector may be fabricated from any suitable material or combination of materials. Each of the tubular housings 401 and the handle 407 could be fabricated from plastic and could include an anti-microbial coating.

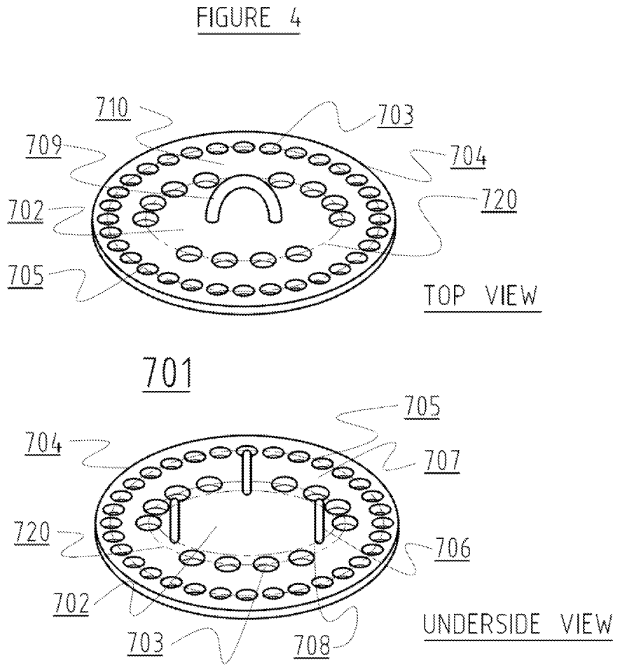

FIG. 4 shows a top and underside views of an example of means for regulating a flow of fluid, e.g., a baffle plate 701, for use with fluid treatment apparatuses of the present disclosure. In use, when the fluid treatment apparatus is installed/connected to a fluid circuit of a heating and/or cooling system, the baffle plate 701 may be removably locatable in the vessel of the fluid treatment apparatus in order to modulate the flow of circulating fluid within a vessel of the fluid treatment apparatus.

Optionally, and as shown in this example, the baffle plate 701 is substantially circular, so as to complement a circular cross-sectional shape of a vessel with which the baffle plate is to be used.

The baffle plate 701 has a solid/rigid central portion 702 and defines a plurality of apertures 703 therein. The apertures are spaced inwardly from the outer edge 704 of the baffle plate. In the example shown, the baffle plate 701 defines thirty-two equally sized circular apertures, spaced equidistantly around an outer ring 705 and a further twelve larger circular apertures around an inner ring 720. It is to be appreciated however that the baffle plate may define a different number of apertures, which may be equally or differently sized, of any suitable shape and in any suitable arrangement.

Optionally, and as shown in this example, the baffle plate 701 further comprises a handle 709 on an upper side 710 thereof. In this example, the handle 709 is a lifting eye, located substantially centrally of the baffle plate 701. The handle 709 may take any suitable form and suitable arrangement.

Optionally, and as shown in this example, the baffle plate 701 comprises a plurality of protruding members/portions 706 that extend away from the major surface of the baffle plate. Such protruding members/portions may serve as stability legs, extending from the underside 707 of the baffle plate 701 thereof. In this example, the baffle plate 701 defines three stability legs of equal length, spaced equidistantly around a ring 708. It is to be appreciated however that the baffle plate 701 may comprise a different number of stability legs 706, in any suitable arrangement.

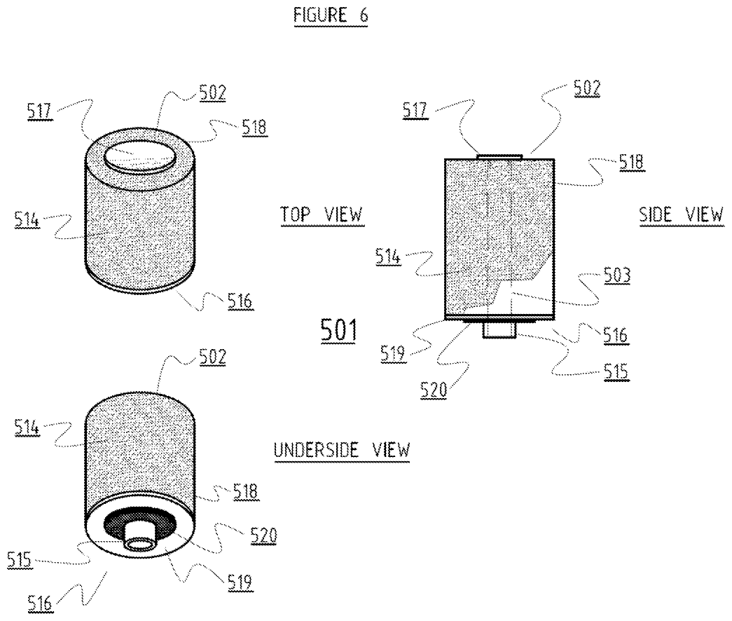

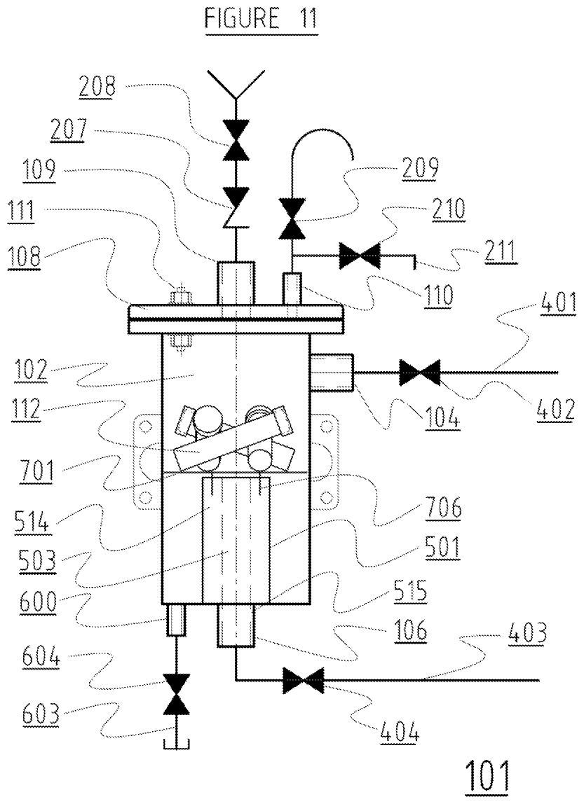

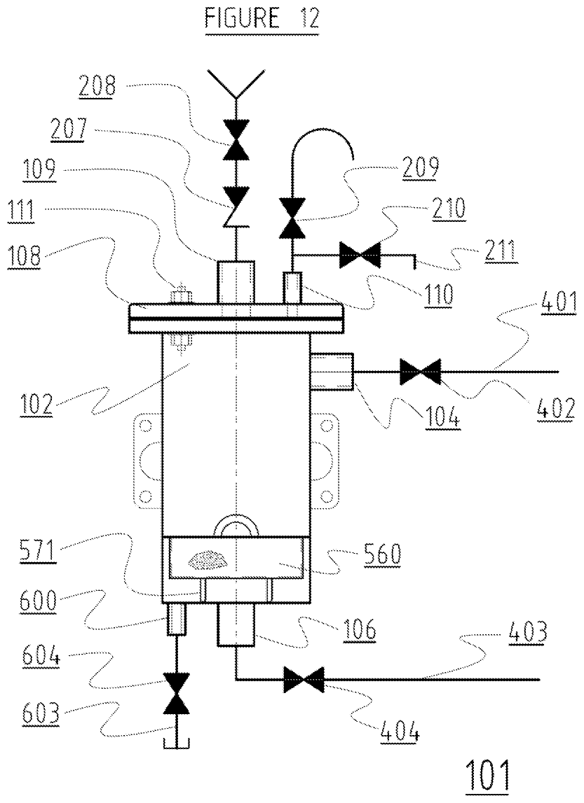

As will be discussed further below with respect to FIG. 11, the provision of protruding members/portions/legs 706 may advantageously serve to stabilise a top of a cartridge filter 501, during installation and operation of a fluid treatment apparatus in accordance with the present disclosure by penetrating a filtration media 514 on an upper end 502 of the cartridge filter 501 such as shown in FIG. 6 (e.g., at an upper exposed peripheral end portion of the filtration media 514 which is not covered by a cap 517). In this regard, the protruding members/portions/legs 706 may be provided with a pointed/tapered/sharpened end or tip. Also, as will be discussed further below with respect to FIG. 12, the provision of protruding members/portions/legs 706 may advantageously serve to support/mount the baffle plate 701 above an internal floor of a vessel 102 during further types of filtration described further below with respect to FIG. 12.

The dimensions and shape of the baffle plate 701 may vary between applications. Components of the baffle plate 701 may be fabricated from any suitable material or combination of materials. The baffle plate 701 and the handle 709 can each be fabricated from plastic and includes an anti-microbial coating. The baffle plate 701 is advantageously benefitted by providing an anti-microbial coating to prevent the growth of bacteria on the baffle plate 701.

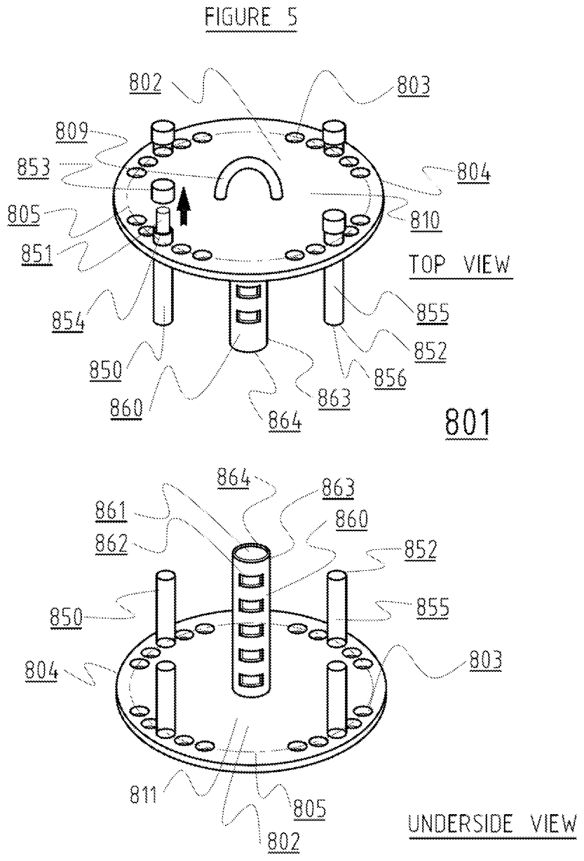

FIG. 5 shows a top and underside views of another example of means for regulating a flow of fluid within the vessel, e.g., a baffle plate, for use with a fluid treatment apparatus of the present disclosure; namely in this instance, a combined baffle plate and permanent magnet collector 801 (e.g., a unitary body comprising a baffle plate and a permanent magnet collector). The combined baffle plate and permanent magnet collector 801 is removably locatable within a vessel of the fluid treatment apparatus. The combined baffle plate and permanent magnet collector 801 is substantially circular, to complement a circular cross-sectional shape of a vessel with which the baffle plate is to be used.

The combined baffle plate and permanent magnet collector 801 has a solid central portion 802 and comprises a plurality of permanent magnet collectors 850. In this example, the combined baffle plate and permanent magnet collector 801 defines four equally sized magnetic filtering means 850 for magnetically filtering/collecting magnetic material/matter/solids (e.g., permanent magnet collectors 850) spaced quarterly around the combined baffle plate and permanent magnet collector 801 and equidistantly from an outer ring 805. The permanent magnet collector 850 comprises a plurality of housings for a plurality of magnetic members 851 (e.g., permanent magnets 851), such as tubular housings 852 housing the permanent magnet 851.

Optionally, and as shown in this example, at least one end 854 of each of the tubular housings 852 is provided with a removable cover 853, in order to allow the selective removal of the permanent magnet 851 housed therein. The cover 853 can be located on the upper side 810 thereof, and the tubular housing 852 containing the permanent magnet 851 can be located on underside 811 thereof.

The combined baffle plate and permanent magnet collector 801 is advantageously benefitted by including the permanent magnet collectors 850 within the body of the combined baffle plate and permanent magnet collector 801 (with the tubular housing 852 containing the permanent magnet 851 located on the underside 811 of the combined baffle plate and permanent magnet collector 801). This may enable a reduction in the overall height of a vessel 101 within which the combined baffle plate and permanent magnet collector 801 is removably located, and may thereby enable a more compact fluid treatment apparatus.

The combined baffle plate and permanent magnet collector 801 can have an anti-microbial and non-magnetic surface. This beneficially reduces/prevents the growth of bacteria on the combined baffle plate and permanent magnet collector 801 and also enables magnetic particles, collected on the external collection surface 855 of a tubular housing 852, to be removed by a process of removing each permanent magnet 851 from within its tubular housing 852 and allowing the magnetic particles to drop from the external collection surface 855 of the tubular housing 852. The permanent magnet 851 is then subsequently replaced inside its tubular housing 852 and the cover 853 replaced.

In this example, the combined baffle plate and permanent magnet collector 801 defines four tubular housings 852 of equal length. The lower end 856 of the tubular housing 852, when located in a vessel, can rest on an internal floor of the vessel 102 via the extending/protruding tubular housings 852. Such protruding tubular housings may thereby provide a functionality equivalent to the protruding members/portions/legs 706 of FIG. 4.

This feature can serve to mount the combined baffle plate and permanent magnet collector 801 above an internal floor of a vessel 102 during further types of filtration as will be described further below with respect to FIG. 12.

It is to be appreciated that the combined baffle plate and permanent magnet collector 801 may comprise a different number of tubular housings 852, in any suitable arrangement.

The combined baffle plate and permanent magnet collector 801 comprises a plurality of apertures 803 therein, spaced inwardly from the outer edge 804 thereof. In this example, the combined baffle plate and permanent magnet collector 801 comprises sixteen equally sized circular apertures, spaced two apertures either side equidistantly from the permanent magnet collectors 850 around an outer ring 805. In such a manner, the apertures 803 are essentially arranged to be clustered/proximal to each of the permanent magnet collectors 850. It is to be appreciated that the location of the apertures 803 is adjacent to the external collection surface 855 of a tubular housing 852 so that any magnetic particles are adjacent to the external collection surface 855 of the tubular housing 852 and are therefore attracted to the external collection surface 855 by the permanent magnet 851 located within the tubular housing 852.

Such location of the apertures 803 adjacent to the external collection surface 855 of a tubular housing 852 beneficially guides fluids containing magnetic particles closer to the external collection surface 855 of permanent magnet 851 and, by removing more magnetic particles from the system fluid (e.g., fill fluid newly introduced via a filling operation, via the combined drain and water inlet port 600, as described below with respect to FIGS. 9 and 10) before the system fluid passes through a filter 501 (e.g., a cartridge filter), thereby extending the lifespan of the cartridge filter.

It is to be appreciated however that the combined baffle plate and permanent magnet collector 801 may define a different number of apertures 803 and a different number permanent magnet collectors 850, which may be equally or differently sized, of any suitable shape and in any suitable arrangement.

The combined baffle plate and permanent magnet collector 801 further comprises a handle 809 on the upper side 810 thereof. In this example, the handle 809 is a lifting eye, located substantially centrally of the combined baffle plate and permanent magnet collector 801. The handle 809 may take any suitable form and suitable arrangement.

The dimensions and shape of the combined baffle plate and permanent magnet collector 801 may also vary between applications. Components of the combined baffle plate and permanent magnet collector 801 may be fabricated from any suitable material or combination of materials. The combined baffle plate and permanent magnet collector 801 and the handle 809 can each be fabricated from plastic and can each include an anti-microbial coating.

Optionally, and in the example shown, the combined baffle plate and permanent magnet collector 801 further comprises an elongate shaft, e.g., an internal cartridge filter shaft 860, which may be centrally disposed on the underside 811 thereof. The internal cartridge filter shaft 860 has a hollow central portion 861 and is substantially circular, to complement/mate with a circular cross-sectional shape of a circulating fluid outlet port 106 at a lower end of a vessel 101 of the fluid treatment apparatus with which the internal cartridge filter shaft 860 is to be used.

The internal cartridge filter shaft 860 defines a plurality of apertures 862 therein, spaced equidistantly vertically and around the circumference of the cartridge filter shaft 860. In this example, the internal cartridge filter shaft 860 defines five (visible) equally sized rectangular apertures, it is to be appreciated in this figure, further apertures 862 will be located on the non-visible part of the cartridge filter shaft 860.

Optionally, and in the example shown, the internal cartridge filter shaft 860, further comprises a lower end 863, a location spigot 864 at the lower end 863 thereof. The location spigot 864 provides stability for a hollow central portion 861 of the internal cartridge filter shaft 860 at the lower end 863 thereof. The location spigot 864 is dimensioned to be located within the circulating fluid outlet port 106 at the lower end of a vessel 101 with which the filter is to be used. This feature serves to stabilise the filter at the lower end 863 during installation and when in use.

The combined baffle plate and permanent magnet collector 801 is advantageously benefitted by providing an internal cartridge filter shaft 860 to provide further stability of combined baffle plate and permanent magnet collector 801, when installed/mounted in use in fluid treatment apparatuses of the present disclosure.

FIG. 6 shows top, side and underside views of an example of filtering means, namely a cartridge type filter 501, for use with fluid treatment apparatuses of the present disclosure.

The cartridge filter 501 is removably locatable within a vessel 102 of a fluid treatment apparatus in accordance with the present disclosure. The cartridge filter 501 is configured to filtering corrosion particles, bacteria (for example corrosion particles from corroded pipework and pseudomonas bacteria) from initial fill fluid, e.g., mains water supply, as well as (pre-)existing fluid/circulating fluid of a heating and/or cooling system. The cartridge filter 501 is also configured to be used in the de-oxygenating/de-gassing of the initial filling fluid as well as (pre-)existing fluid/circulating fluid of a heating and/or cooling system.

The cartridge filter 501 is substantially circular, to complement a circular cross-sectional shape of a vessel 102 with which the filter is to be used.

The cartridge filter 501 may comprise any suitable filtration media and can include an anti-microbial coating.

Optionally, and as shown, the filter 501 has an upper end 502, a lower end 516 and defines a hollow central core 503 that is surrounded by filtration media 514. The filtration media 514 can have a fluid filter rating in the range 0.5-50 micrometres. The filter 501 may be a 0.5 μm filter which would be suitable to capture pseudomonas bacteria. The filtration media 514 can be soft/pliable and easily penetrable in nature, not least for example by the stability legs 706 of the baffle plate 701 of FIG. 4. A typical type of material for the filtration media 514 could be a blown nylon or polypropylene type structure.

It is known that coalescence of oxygen will take place during a pressure drop of a fluid. For example, as a coke bottle is opened and a pressure drop is produced within the bottle, carbon-dioxide which is present as a dissolved gas precipitates out of solution and forms micro-bubbles of carbon dioxide. Coalescence can occur within a vessel 102 of a fluid treatment apparatus during an initial filling fluid process, and can also occur for (pre-)existing fluid/circulating fluid of a heating and/or cooling system as it enters the vessel 102. Advantageously, the filtration media 514 of the cartridge filter 501 (e.g., the blown nylon or polypropylene type structure) can promote the formation of oxygen micro-bubbles upon the outer edge 518 of the filtration media 514.

The cartridge filter 501 may be a 0.5 μm filter which would be suitable to capture pseudomonas bacteria and further the cartridge filter 501 can be configured to neutralise the bacteria by the use of an anti-microbial coating therein/thereon.

Optionally, and as shown in this example, the upper end 502 of the cartridge filter 501 defines a top cap 517. The top cap 517 provides stability for the hollow central core 503 and the filtration media 514. The top cap 517 does not cover to the outer edge 518 of the filtration media 514 on the horizontal surface of the upper end 502 of the cartridge filter 501. This allows for the stability legs 706 of the baffle plate 701 to penetrate the filtration media 514 between the outer edge of the top cap 517 and the outer edge 518 of the filtration media 514, thus preventing any horizontal movement of the cartridge filter 501 from the upper end 502 of the cartridge filter 501.

Optionally, and as shown in this example, the cartridge filter 501, has a bottom cap 519, a rubber gasket 520, a location spigot 515 at the lower end 516 thereof. The bottom cap 519 provides stability for the hollow central core 503 and the filtration media 514. The bottom cap 519 covers to the outer edge 518 of the filtration media 514 on the horizontal surface of the lower end 516 of the cartridge filter 501.

The location spigot 515 is dimensioned to be located within the circulating fluid outlet port 106 at the lower end of a vessel 101 of the fluid filter apparatus with which the filter is to be used. This feature serves to stabilise the filter at the lower end 516 during installation and when in use.

There is a rubber gasket 520 which is located over the location spigot 515 and against the bottom cap 519. This serves to form a fluid seal between the cartridge filter 501 and the circulating fluid outlet port 106 at the lower end of a vessel 101.

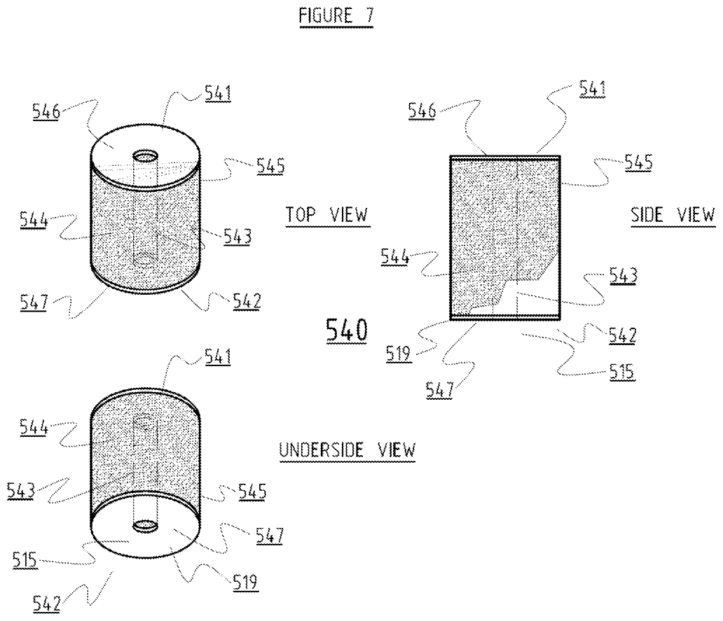

FIG. 7 shows an example of another filtering means, i.e., cartridge filter 540, suitable for use with the combined baffle plate and magnet collector 801 of FIG. 5. The cartridge filter 540 is removably locatable within a vessel 102 of a fluid treatment apparatus in accordance with the present disclosure. The cartridge filter 540 is configured to filter: debris, detritus, corrosion particles and/or bacteria; for example, corrosion particles from corroded pipework and pseudomonas bacteria from the initial fill fluid (mains water supply) and the circulating fluid of a heating and/or cooling system. The cartridge filter 540 is also configured to be used in the de-oxygenating of the initial filling fluid and the de-oxygenating of fluid in a fluid circuit of a heating and/or cooling system.

The cartridge filter 540 is substantially circular, to complement a circular cross-sectional shape of a vessel 102 within which the filter is to be used.

The cartridge filter 540 may comprise any suitable filtration media and may include an anti-microbial coating. Optionally, and as shown in this example, the filter 540 has: a top cap 546 in an upper end 541 thereof, a bottom cap 547 in the lower end 542 thereof, a hollow central core 543 that is surrounded by filtration media 544. The hollow central core 543 interconnects between the top cap 546 and the bottom cap 547.

The top cap 546 locates and provides stability for the internal cartridge filter shaft. The top cap 546 extends/covers to the outer edge 545 of the filtration media 544 on a horizontal surface of the upper end 541 of the cartridge filter 540. This allows for the top cap 546 of the cartridge filter 540 to sit flush with an underside of the combined baffle plate and permanent magnet collector of FIG. 5.

The bottom cap 547 extends/covers to the outer edge 545 of the filtration media 544 on the horizontal surface of the lower end 542 of the cartridge filter 540. This allows for the bottom cap 547 of the cartridge filter 540 to sit flush with an internal floor of the vessel 102.

The filtration media 544 can have a fluid filter rating in the range 0.5-50 micrometres. The material for the filtration media 544 may be a blown nylon or polypropylene type structure. The cartridge filter 540 may be a 0.5 μm filter which would be suitable to capture pseudomonas bacteria. The cartridge filter 540 may also comprise an anti-microbial coating for reducing/preventing the growth of bacteria on the cartridge filter and/or neutralising bacteria in the fluid.

Similar to that discussed above with respect to the cartridge filter 501 of FIG. 6, the cartridge filter 540 can promote the formation of oxygen/air/gas micro-bubbles on the filtration media 544 (e.g., upon an outer edge 545 of the filtration media 544 via the use of a blown nylon or polypropylene type structure for the filtration media) and may thereby reduce/remove oxygen/air/gas dissolved in the fluid which may otherwise enhance corrosion of pipework of the heating and/or cooling system.

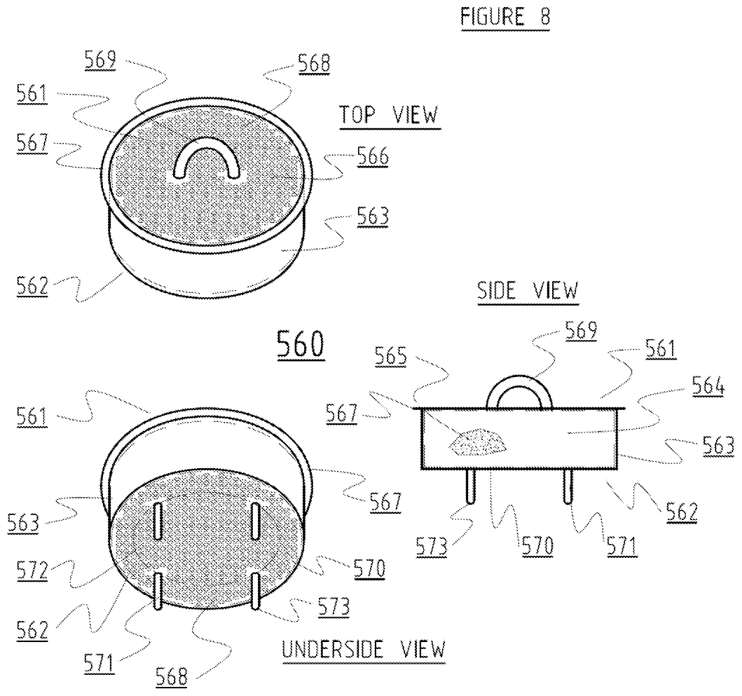

FIG. 8 shows a top, side and underside view of an example of means for removing dissolved metal from a fluid, i.e., a basket type filter 560, for use with fluid treatment apparatuses in accordance with the present disclosure. The basket filter 560 is removably locatable within a vessel 102 of the fluid treatment apparatus. The basket filter 560 is configured to filter dissolved solids from the circulating fluid of a heating and/or cooling system, for example ‘dissolved iron’.

The basket filter 560 is substantially circular, to complement a circular cross-sectional shape of a vessel 102 of the fluid treatment apparatus within which the basket filter is to be used.

The basket filter 560 has an upper end 561, a lower end 562, an outer edge 563 and defines a hollow central cavity/void/core 564 within which a filtration media 565 is disposed. The filtration media 565 may be configured to filter dissolved solids, such as metals, from the circulating fluid of a heating and/or cooling system, for example ‘dissolved iron’.

The filtration media 565 can be an insoluble catalyst of a granular type. The material for the filtration media 565 can be a mixture of ‘Silica, crystalline quartz, Aluminium silicate, Manganese dioxide’.

The upper end 561 of the basket filter 560 can define a removable lid 566. The removable lid 566 can provide access to the hollow central core 564, e.g., to enable the filtration media 565 to be placed within the hollow central core 564 and to be removed from the hollow central core 564 for cleaning purposes. The removable lid 566 can extend to the outer edge 563 of the basket filter 560 on the horizontal surface of the upper end 561.

A flexible seal 567 may be located around the outer edge 563 circumference of the upper end 561 of the basket filter 560. When the basket filter 560 is located within a vessel 102 of the fluid treatment apparatus, the flexible seal 567 forms a watertight seal between the circumference of the upper end 561 of the basket filter 560 and the internal side wall of the vessel 102.

The removable lid 566 may comprise a plurality of apertures 568 therein, spaced inwardly from the outer edge 563 thereof. The removable lid 566 may define a large amount of equally sized circular apertures 568 and spaced equidistantly.

It is to be appreciated however that the removable lid 566 may define a different number of apertures 568, which may be equally or differently sized, of any suitable shape and in any suitable arrangement.

Optionally, and as shown in this example, the removable lid 566 further comprises a handle 569 on the upper end 561 thereof. In this example, the handle 569 is a lifting eye, located substantially centrally of the removable lid 566. The handle 569 may take any suitable form and suitable arrangement.

The lower end 562 of the basket filter 560 defines a fixed bottom 570. The fixed bottom 570 defines a plurality of equally sized circular apertures 568 and spaced equidistantly therein and spaced inwardly from the outer edge 563 thereof. It is to be appreciated however the fixed bottom 570 may define a different number of apertures 568, which may be equally or differently sized, of any suitable shape and in any suitable arrangement.

The apertures 568 allow for the circulating fluid of a heating and/or cooling system to flow directly through the basket filter 560 in a vertical plane.

Optionally, and as shown in this example, the fixed bottom 570 comprises a plurality of protruding members/protrusions 571 that serve as stability legs extending from the lower end 562 of the fixed bottom 570. In this example, the fixed bottom 570 defines four stability legs 571 of equal length, spaced equidistantly around a ring 572. The lower end 573 of the stability legs 571 when located in a vessel can rest on the internal floor of the vessel 102. This feature serves to stabilise the basket filter 560 during installation and operation.

It is to be appreciated however that the basket filter 560 may comprise a different number of stability legs 571, in any suitable arrangement.

FIG. 9 shows a schematic diagram of the fluid treatment apparatus of 101 of FIG. 1 during a process of introduction of new fluid (i.e., “fill fluid”, such as from a temporary connection to a mains water supply) to fill an empty fluid circuit of a heating and/or cooling system.

As will be discussed below, the new fill fluid: is received into the vessel via the combined drain and water inlet port 600, then passes through the filter, and then leaves the vessel via the circulating fluid outlet port 106 and enters into the fluid circuit of the heating and/or cooling system to fill the same.

The passing of the new fluid through the filter of the vessel prior to entering into and filling up the empty fluid circuit of a heating and/or cooling system, may de-oxygenate and pre-treat/filter the newly introduced fluid prior to entering the fluid circuit.

In an example method of installing the fluid treatment apparatus of 101, the circulating fluid inlet port 104 is connected to a circulating fluid inflow conduit 401 via an associated isolation valve 402. The circulating fluid outlet port 106 is connected to a circulating fluid outflow conduit 403 via an associated isolation valve 404. The combined drain and water inlet port 600 is connected to a drain and fill conduit 603 (e.g., a permanent drain and fill conduit) via an associated isolation valve 604.

A fill supply conduit 601 is connected to an incoming mains water supply via an associated isolation valve 605. A temporary fluid connection 602 is installed to connect the drain and fill conduit 603 and the fill supply conduit 601.

When installing the fluid treatment apparatus, the filter 501 of FIG. 6 (e.g., a 0.5 μm filter which would be suitable to capture pseudomonas bacteria) may be placed into the vessel 102 first, the baffle plate 701 of FIG. 4 can then be placed into the vessel 102 upon the filter 501, and then the permanent magnet collector 112 of FIG. 3 can placed into the vessel 102 upon the baffle plate 701. Thus, as shown in this figure, the permanent magnet collector, filter and baffle plate are located within the vessel such that the filter is lowermost, the permanent magnet collector is uppermost, and the baffle plate is located between the filter and the permanent magnet collector. The weight of the baffle plate and permanent magnet collector upon the filter also serves to stabilise the filter in use. After the filter 501 is placed into the vessel 102, the baffle plate 701 is placed into the vessel 102 upon the filter 501, and the permanent magnet collector 112 is placed into the vessel 102 upon the baffle plate 701; the removable lid 108 is installed and secured with the mechanical fixings 111—thereby sealing the vessel 102.

As shown in this figure, the dosing port 109 is provided with a non-return valve 207, to negate any reverse flow of fluid, and an associated isolation valve 208 is provided upstream of the non-return valve 207.

The air vent port 110 is provided with an automatic air vent 209, and a manual air vent 211 via associated isolation valve 210 upstream of the automatic air vent 209. The automatic air vent 209 of the air vent port 110 is configured to remove excess air, and may be beneficially operational during a filling event.

The manually operable air vent 211 may be closed, via the associated isolation valve 210, before the fill fluid, e.g., mains water supply filling fluid, is introduced into the vessel 102 through the combined drain and water inlet port 600.

Opening of the isolation valve 210 can allow the manually operable air vent 210 to act faster in the removal of excess air from within the vessel 102 during the introduction of mains water supply filling fluid into the vessel 102 and is beneficially operational during a filling event.

The installed fluid treatment apparatus 101 is usable during the introduction of new fluid to an empty fluid circuit in order to part de-oxygenate/de-gas the new fluid prior to entering into a fluid circuit, and also pre-treat the new fluid prior to entering the fluid circuit of a heating and/or cooling system (e.g., by virtue of the new fluid, having entered the vessel via the combined drain and water inlet port 600, being forced to pass though the filter prior leaving the vessel, via the circulating fluid outlet port 106, and entering the fluid circuit).

The vessel 102 can be isolated from the fluid circuit by means of the isolation valves 402 and 404 of the circulating fluid inlet port 104 and the circulating fluid outlet port 106. The isolating valve 210 may require closing before commencement of the introduction of new fluid.

The temporary fluid connection 602 is installed to connect the drain and fill conduit 603 and the fill supply conduit 601. Isolation valves 402, 404, 210, 604 and 605 are all in the closed position.

The isolation valve 605 located on the fill supply conduit 601 is opened. The isolation valve 604 located on the drain and fill conduit 603 is opened to allow new mains water supply filling fluid to flow into the vessel 102 via the combined drain and water inlet port 600.

Isolation valve 210 is opened to allow air to evacuate through the manually operable air vent 211. At the point at which new mains water supply filling fluid escapes through manually operable air vent 211, then isolation valve 210 is to be closed.

The Isolation valve 404 connected to the circulating fluid outflow conduit 403 is opened slowly. As the new mains water supply filling fluid enters the vessel 102, a pressure drop takes place in the fluid within the vessel 102. Coalescence of oxygen may occur, micro-bubbles may form, for example on the external surface of the filter 501. Once formed, the micro-bubbles converge together and, when large enough, rise upwards and evacuate the vessel 102 via the automatic air vent 209 of the air vent port 110. Accordingly, the introduction of the fill fluid (i.e., a new filling fluid e.g., from the mains water supply) to fill the vessel as well as fill a fluid circuit of a heating and/or cooling system via the combined drain and water inlet port 600, may advantageously substantially produce a pressure drop within the vessel 102 and encourage the production of coalescence within the vessel 102, to be exhausted via the air vent port 110. Advantageously, this can reduce/remove of air/dissolved gasses, which are normally found within a filling fluid, prior to the filling fluid entering the fluid circuit heating and/or cooling system, thereby reducing the potential for corrosion within the heating and/or cooling system due to air/dissolved gasses in the circulating fluid.

When the new mains water supply filling fluid passes through the filter 501, any dirt particles or debris contamination conveyed into the vessel 102 from within the new mains water supply filling fluid are captured by the filter and filtered out of the fluid prior to the fluid entering the heating and/or cooling system. Advantageously, the use of the combined drain and water inlet port 600 in a filling operation, and the use of the filter 501 which is located upstream of the combined drain and water inlet port 600 (i.e. with regards to the path of fluid within the vessel, the combined drain and water inlet port 600 is located upstream of the filter, i.e. such that the fluid would pass through the filter after passing through the combined drain and water inlet port 600), enables a pre-treatment of the filling fluid prior to entry into the fluid circuit of the heating and/or cooling system, which may thereby reduce the potential for blockages and efficiency reductions of the heating and/or cooling system due to the accumulation dirt/debris in its fluid circuit, as well as reduce the potential for corrosion due to dirt/debris/contamination.

Moreover, when the new mains water supply filling fluid passes through the filter 501 (e.g., a 0.5 μm filter), any bacteria (such as Pseudomonas)>0.5 μm will be captured by the filter 501. Yet further, any bacteria captured by the filter 501 may be neutralised by any anti-microbial coating provided on the filter 501 so as to prevent the filter 501 becoming prematurely blocked by biofilm. Advantageously, the use of the combined drain and water inlet port 600 and the filter 501 as pre-treatment for the filling fluid may reduce/substantially remove bacteria normally found within a filling fluid prior to the filling fluid entering the heating and/or cooling system, thereby reducing the potential for Microbially Influenced Corrosion (MIC), bacteria and biofilm growth within the heating and/or cooling system as well as reduce the potential for blockages and efficiency reductions due to the same.

The now cleaned, filtered and bacteria free new mains water supply filling fluid exits the vessel 102 via the circulating fluid outlet port 106 and into the circulating fluid outflow conduit 403 of a fluid circuit of a heating and/or cooling system. The heating and/or cooling system is thereby filled with ‘pre-treated’ newly introduced filling fluid (i.e., ‘pre-treated’ newly introduced mains water),

In order to enable access to as well as the cleaning and/or replacement of the inside of the vessel and/or its internal components (not least the: permanent magnet collector 112, the filter 501, and/or the baffle plate 701) the vessel 102 can be isolated and drained (i.e., isolated from the fluid circuit of the heating and/or cooling system, and drained for enabling access to the removable permanent magnet collector 112 and filter 501 within the vessel).

In this regard: the isolating valve 404, located on the circulating fluid outflow conduit 403, can be closed; the isolating valve 604 located on the drain and fill conduit 603 can be closed; and the isolating valve 605 located on the fill supply conduit 601 can be closed. If the temporary fluid connection 602 is still connected to the drain and fill conduit 603 and the fill supply conduit 601, then the temporary fluid connection 602 is disconnected from both the drain and fill conduit 603 and the fill supply conduit 601. The vessel 102 would then be isolated from the fluid circuit of the heating and/or cooling system.

When required, to drain the vessel 102, the isolation valve 604 for the drain and fill conduit 603 is opened to allow fluid within the vessel 102 to leave through the combined drain and fill conduit 603. Since the combined drain and fill conduit 603 is located upstream of the filter 501 (i.e. with regards to the path of fluid within the vessel, the combined drain and water inlet port 600 is located upstream of the filter, i.e. such that the fluid would pass through the combined drain and water inlet port 600 prior to passing through the filter), advantageously, fluid within the vessel can be drained out of the vessel directly via through the combined drain and fill conduit 603 and does not need to pass through the filter. Thus, if the filter were blocked, this would not affect the draining of the fluid from the vessel [in contradistinction, if draining of the fluid were sought to be done via the circulating fluid outlet port 106, since the circulating fluid outlet port 106 is downstream of the filter, if the filter were dirty/blocked then fluid within the vessel (particularly fluid inside the vessel outside/external of the filter) would not be able to drain out of the circulating fluid outlet port 106, or its flow rate may be impeded by a partially/substantially dirty/blocked filter]. Advantageously, the use of the combined drain and water inlet port 600 in a draining operation may enable improved draining performance as compared to draining via the circulating fluid outlet port 106, particularly where the filter is partially/fully blocked.

When the vessel 102 is isolated from the fluid circuit of the heating and/or cooling system and the vessel 102 is drained, the removable lid 108 can be removed by loosening the mechanical fixings 111. Following which, the permanent magnet collector 112, which is located in the vessel 102, can be removed. With the permanent magnet collector 112 removed from the vessel, any collected magnetic particles may be removed from the external collection surface 113 as previously described with respect to FIG. 3. The baffle plate 701 can then be removed and cleaned of any dirt or debris contamination, e.g., with a cloth. Then the filter 501 can be removed and replaced with a new clean filter 501. Such a new clean filter 501 can be located into the vessel 102, the baffle plate 701 can then be placed into the vessel 102 upon the filter 501, and then the permanent magnet collector 112 can be placed into the vessel 102 upon the baffle plate 701.

Following a draining and cleaning operation, the drain and fill conduit 603 can be subsequently closed off by returning the isolation valve 604 to a closed position.

FIG. 10 shows a schematic diagram of the fluid treatment apparatus of 101 of FIG. 2 during a process of introduction of new fluid to an empty fluid circuit of a heating and/or cooling system.

The process of filling and draining the fluid treatment apparatus of FIG. 10 is the same as the process described above with respect to FIG. 9.

The fluid treatment apparatus of FIG. 10 is similar to the fluid treatment apparatus of FIG. 9. However, in the fluid treatment apparatus of FIG. 10: the combined drain and water inlet port 600 is located in a lower end 107 in a side wall 105, the cartridge filter 540 of FIG. 7 is used, and the combined baffle plate and permanent magnet collector 801 of FIG. 5 is used.

The combined drain and water inlet port 600 is located in a lower end 107 in a side wall 105 and is connected to a permanent drain and fill conduit 603 via an associated isolation valve 604. The fill supply conduit 601 is connected to the incoming mains water supply via an associated isolation valve 605. A temporary fluid connection 602 is installed to connect drain and fill conduit 603 (e.g., a permanent drain and fill conduit) and the fill supply conduit 601.

The cartridge filter 540 is located over/around an internal cartridge filter shaft 860 of the combined baffle plate and permanent magnet collector 801. The combined baffle plate and permanent magnet collector 801 combined with the cartridge filter 540 are then located into the vessel 102 with a location spigot 515, which is dimensioned to be located within the circulating fluid outlet port 106 at the lower end 107 of a vessel 102 with which the filter 540 and combined baffle plate and permanent magnet collector 801 is to be used. This feature serves to stabilise the filter 540 and combined baffle plate and permanent magnet collector 801 at the lower end during installation and when in use.

The use of the combined baffle plate and permanent magnet collector 801 may advantageously reduce spatial requirements within the vessel 102 due to combining the two features into one combined feature, and hence may provide a more compact vessel (e.g., more compact as compared to the vessel of FIG. 9).

FIG. 11 shows a schematic diagram of a fluid treatment apparatus of 101.

As with the above-described fluid treatment apparatus, the fluid treatment apparatus of FIG. 11 is suitable for enabling: the part de-oxygenating of existing circulating fluid of a fluid circuit of a heating and/or cooling system; and the treatment of existing circulating fluid to a fluid circuit a heating and/or cooling system.

The fluid treatment apparatus of FIG. 11 comprises: the vessel 102 of the fluid treatment apparatus 101 of FIG. 1, the permanent magnet collector 112 of FIG. 3, the baffle plate 701 of FIG. 4 and the filter 501 of FIG. 6.

In a method of installing the fluid treatment apparatus, the filter 501 is placed into the vessel 102 first, such that the location spigot 515 is located within the circulating fluid outlet port 106 of the vessel 102. The baffle plate 701 is then placed into the vessel 102 upon the filter 501, such that the stability legs 706 of the baffle plate 701 are located within the filtration media 514 of the filter 501. In some examples, the stability legs 706 are configured so as to be able to penetrate the filtration media, e.g., via the provision of sharpened/pointed end portions. The permanent magnet collector 112 is then placed into the vessel 102 upon the baffle plate 701.

Thus, as shown in FIG. 11 the permanent magnet collector 112, filter 501 and baffle plate 701 are arranged within the vessel such that existing circulating fluid flowing through the vessel 102 passes the permanent magnet collector 112 and subsequently passes, along a path directed by the baffle plate 701, into the filtration media 514 of the filter 501 and out through the hollow central core 503 of the filter 501 and into the circulating fluid outlet port 106 of the vessel 102.

The vessel 102 can be isolated from a fluid circuit of the heating and/or cooling system by means of isolation valves 402 and 404 of the circulating fluid inlet port 104 and the circulating fluid outlet port 106 respectively. The isolating valves 604 and 210 may also require closing before commencement of the introduction of existing circulating fluid.

A method of use of the fluid treatment apparatus described herein with existing circulating fluid of a heating and/or cooling system will now be described.

A filter 501 (0.5 μm filter which would be suitable to capture pseudomonas bacteria) is located into the vessel 102, the baffle plate 701 is then placed into the vessel 102 upon the filter 501, and then the permanent magnet collector 112 is placed into the vessel 102 upon the baffle plate 701. The removable lid 108 is installed and secured with the mechanical fixings 111 which then seals the vessel 102. Isolation valves 402, 404, 210 and 604 are all placed in the closed position.

A dosing port 109 is provided with a non-return valve 207, to negate any reverse flow of fluid, and an associated isolation valve 208 is provided upstream of the non-return valve 207.

An air vent port 110 is provided with an automatic air vent 209, and a manual air vent 211 via associated isolation valve 210 upstream of the automatic air vent 209. The automatic air vent 209 of the air vent port 110 functions to remove excess air and is beneficially operational during a filtering and part de-oxygenating event.

In a method of performing a filtering and part de-oxygenating event, e.g., performing filtering and part de-oxygenating of existing circulating fluid, the manually operable air vent 211 is closed via the associated isolation valve 210 before the existing circulating fluid is introduced into the vessel 102.

The opening of the isolation valve 210 allows the manually operable air vent 210 to act faster in the removal of excess air from within the vessel 102 during the introduction of existing circulating fluid into the vessel 102 and is beneficially operational during a filling escribed above.

An isolation valve 402 connected to the circulating fluid inflow conduit 401 may be opened slowly. Existing circulating fluid will now ingress into the vessel 102 via the circulating fluid inlet port 104. Isolation valve 210 is opened to allow air to evacuate through the manually operable air vent 211. At the point at which existing circulating fluid escapes through manually operable air vent 211, then isolation valve 210 is to be closed.

The isolation valve 404, connected to the circulating fluid outflow conduit 403, may be opened slowly. As the existing circulating fluid enters the vessel 102, via the circulating fluid inlet port 104, a pressure drop now takes place of the fluid within the vessel 102. Coalescence of oxygen now occurs with the existing circulating fluid within the vessel 102, micro-bubbles may form for example on the external surface of the filter 501. Once formed the micro-bubbles converge together and, when large enough, rise upwards and evacuate the vessel 102 via the automatic air vent 209 of the air vent port 110.

As the existing circulating fluid passes through the vessel 102, any magnetic debris/dirt particles carried into the vessel 102 from within the existing circulating fluid will be attracted to the external collection surface 405 of a tubular housing 401 permanent magnet collector 112 and collected/filtered thereby, e.g., as previously described with respect to FIG. 3.

The existing circulating fluid then passes through the apertures of the baffle plate 701 and to the filter 501. As the existing circulating fluid passes through the filter 501. Any (non-magnetic) dirt particles carried into the vessel 102 from within the existing circulating fluid will be captured by the filter 501. With an appropriate filter (e.g., with a rating of <5 μm), any bacteria (such as Pseudomonas)>0.5 μm will be captured by the filter 501. Further, any bacteria captured by the filter 501 may be neutralised by providing an anti-microbial coating on the filter 501—thereby preventing the filter 501 becoming prematurely blocked by biofilm.

The now cleaned, filtered, bacteria free and oxygen depleted existing circulating fluid exits the vessel 102 via the circulating fluid outlet port 106 and enters into the circulating fluid outflow conduit 403 of the fluid circuit of the heating and/or cooling system.

After a period of time, for example 1-2 weeks, the permanent magnet collector 112 and filter 501 may be subsequently checked at regular maintenance intervals. The permanent magnet collector 112 may be cleaned as required, and the filter 501 may be replaced when blocked as required.

To carry out the regular maintenance and the draining of the vessel 102, the vessel 102 will need to be isolated and drained to enable the cleaning and replacement of the permanent magnet collector 112 and the filter 501, via a process similar to that described above. In this regard, the isolating valve 404, located on the circulating fluid outflow conduit 403 is closed. The isolation valve 402, located on the circulating fluid inflow conduit 401, is also closed. The vessel 102 is now isolated from the fluid circuit of the heating and/or cooling system.

When required, to drain the vessel 102, the isolation valve 604 for the drain and fill conduit 603 is opened to allow fluid within the vessel 102 to leave through the drain and fill conduit 603, via the isolation valve 604 and via the combined drain and water inlet port 600 (which is located upstream of the filter 501). The drain and fill conduit 603, is subsequently closed by returning the isolation valve 604 to the closed position.

When the vessel 102 is isolated from the fluid circuit of the heating and/or cooling system and the vessel 102 is drained, the removable lid 108 can be removed by loosening the mechanical fixings 111. The permanent magnet collector 112, which is located in the vessel 102, can then be removed. With the permanent magnet collector 112 removed from the vessel, any collected magnetic particles may be removed from the external collection surface 113 as previously described with reference to FIG. 4. The baffle plate 701 can be removed and any dirt or debris contamination can be closed off of the baffle plate 701, e.g., with a cloth. The filter 501 can be removed and replaced. A new clean filter 501 ca be located in the vessel 102. The baffle plate 701 can then be placed into the vessel 102 upon the filter 501, and then the permanent magnet collector 112 can be placed into the vessel 102 upon the baffle plate 701.

The use, in a method of treating fluid in a fluid circuit of a heating and/or cooling system with a fluid treatment apparatus as per FIG. 11, of the circulating fluid inlet port 104 advantageously may substantially produce a pressure drop of the circulating fluid within the vessel 102 when entering the vessel via the circulating fluid inlet port 104. This may encourage the production of coalescence, within the vessel 102, of gasses (such as Oxygen) dissolved in the circulating fluid. Microbubbles may form, e.g., on the surface of the filter. Once formed, the micro-bubbles may converge together and, when large enough, rise upwards and evacuate the vessel 102 via the automatic air vent 209 of the air vent port 110. This may lead to the removal of air normally found within the existing circulating fluid, thereby reducing the potential for corrosion within the heating and/or cooling system.

The use of the filter 501 may also serve to remove bacteria normally found within an existing circulating fluid thereby reducing the potential for corrosion (e.g., MIC), bacteria and biofilm growth within the heating and/or cooling system.

FIG. 12 shows a schematic diagram of a fluid treatment apparatus 101 for the filtering of existing dissolved solids in circulating fluid of a fluid circuit of a heating and/or cooling system.

The fluid treatment apparatus 101 includes the basket type filter 560 of FIG. 8 within the vessel 102 of the fluid treatment apparatus 101 of FIG. 1.

The basket filter 560 is removably locatable within the vessel 102 of the fluid treatment apparatus 101. The basket filter 560 is provided for filtering dissolved solids from the circulating fluid of a heating and/or cooling system.

The basket filter 560 may be arranged within the vessel such that existing circulating fluid flowing through the vessel 102 can pass through the basket filter 560 and into the circulating fluid outlet port 106 of the vessel 102. In this regard, the basket filter 560 may be placed into the vessel 102 (i.e., when the vessel is empty), such that the stability legs 571 are mounted above the internal floor of the vessel 102.

The vessel 102 can be isolated from the fluid circuit by means of the isolation valves 402 and 404 of the circulating fluid inlet port 104 and the circulating fluid outlet port 106 respectively. The isolating valves 604 and 210 may also require closing before commencement of the introduction of existing circulating fluid.

A method of installing and using the fluid treatment apparatus of FIG. 11 for filtering dissolved solids (in particular dissolved metals such as dissolved iron) in circulating fluid of a heating and/or cooling system will now be described.

The basket filter 560 is located into the vessel 102. The basket filter comprises a filter media configured to remove solids dissolved in a fluid, e.g., dissolved metals not least such as dissolved iron. The filter media may comprise an active insoluble catalyst for removing a metal, such as iron, dissolved in a fluid. The filter media may be configured to remove metal, such as iron, via effecting/facilitating a chemical reaction in which the metal dissolved in the fluid is precipitated out of the fluid. The filter media may comprise a Burgess Iron Removal Method filter media.

The removable lid 108 is installed and secured with the mechanical fixings 111, which will then seal the vessel 102. Isolation valves 402, 404, 210 and 604 are all in the closed position.

The dosing port 109 is provided with a non-return valve 207, to negate any reverse flow of fluid, and an associated isolation valve 208 upstream of the non-return valve 207. The air vent port 110 is provided with an automatic air vent 209, and a manual air vent 211 via associated isolation valve 210 upstream of the automatic air vent 209.

The automatic air vent 209 of the air vent port 110 functions to remove excess air and is beneficially operational during a filtering and part de-oxygenating event.

The manually operable air vent 211 may be closed via the associated isolation valve 210 before the circulating fluid is introduced into the vessel 102.

The opening of the isolation valve 210 allows the manually operable air vent 210 to act faster in the removal of excess air from within the vessel 102 during the introduction of circulating fluid into the vessel 102 and is beneficially operational during a filling event.

The Isolation valve 402 connected to the circulating fluid inflow conduit 401 may be opened slowly. Circulating fluid may then ingress into the vessel 102 via the circulating fluid inlet port 104. Isolation valve 210 may be opened to allow air to evacuate from the vessel 102 through the manually operable air vent 211. At the point at which existing circulating fluid escapes through manually operable air vent 211, then isolation valve 210 can be closed.

The Isolation valve 404 connected to the circulating fluid outflow conduit 403 may be opened slowly. As the existing circulating fluid enters the vessel 102, via the circulating fluid inlet port 104, a pressure drop of the fluid within the vessel 102 may take place. Coalescence of oxygen may occur with the circulating fluid within the vessel 102, micro-bubbles may form, for example on the basket filter 560. Once formed, the micro-bubbles may converge together and, when large enough, rise upwards and evacuate the vessel 102 via the automatic air vent 209 of the air vent port 110.

As the existing circulating fluid passes through the basket filter 560, the basket filter 560 filters the dissolved solids from the circulating fluid of a heating and/or cooling system for example ‘dissolved iron’. The now filtered circulating fluid exits the vessel 102 via the circulating fluid outlet port 106 and into the circulating fluid outflow conduit 403 of a fluid circuit of a heating and/or cooling system.

Advantageously, the fluid filter apparatus of FIG. 12 enables the removal of dissolved solids, such as dissolved iron, from contaminated circulating fluid of a heating and/or cooling system is a manner that is more efficient that conventional flushing of the system's pipework with new/clean fluid. The apparatus of FIG. 12 enables a dissolved solid removal process whilst the fluid re-circulates (rather than needing the replacement of the circulating fluid with new/clean fluid). The apparatus thereby reduces an amount of dissolved solids in an efficient manner, in particular so as to reduce the quantity of fluid consumption.

After a period of time, for example 1 week of fluid re-circulation, the basket filter 560 may be subsequently checked at regular maintenance intervals, and the basket filter 560 can be replaced (i.e., to replace the used/stale filtering media with fresh/new filtering media) or removed (i.e., if acceptable levels of dissolved solids/contaminants have been reached) as required.

To carry out the regular maintenance and the draining of the vessel 102. The vessel 102 will need to be isolated and drained to enable the cleaning and replacement of the permanent magnet collector 112 and the basket filter 560. In this regard, the isolating valve 404, located on the circulating fluid outflow conduit 403, is closed. The isolation valve 402, located on the circulating fluid inflow conduit 401, is closed. The vessel 102 is now isolated from the fluid circuit of a heating and/or cooling system.

When required, to drain the vessel 102, the isolation valve 604, for the drain and fill conduit 603 (e.g., a permanent drain and fill conduit), is opened to allow fluid within the vessel 102 to leave through the drain and fill conduit 603, via the isolation valve 604 and via the combined drain and water inlet port 600. The drain and fill conduit 603 is subsequently closed by returning isolation valve 604 to the closed position.

When the vessel 102 is isolated from the fluid circuit of a heating and/or cooling system and the vessel 102 is drained, the removable lid 108 can be removed by loosening the mechanical fixings 111. The basket filter 560, which is located in the vessel 102, can be removed.

Therefore, in a method of treating fluid in a fluid circuit of a heating and/or cooling system with a filtering apparatus as per FIG. 12, the use of the circulating fluid inlet port 104 is beneficially operational to substantially produce a pressure drop within the vessel 102 and encourage the production of coalescence within the vessel 102 leading to the removal of air which is normally found within the circulating fluid prior, so reducing the potential for corrosion within the heating and/or cooling system.

Also, in a method of treating fluid in a fluid circuit of a heating and/or cooling system with a filtering apparatus as per FIG. 12, the use of the basket filter 560 as treatment for the dissolved solids is beneficially operational to substantially remove dissolved iron normally found within an existing circulating fluid of a heating and/or cooling system, so reducing the potential for a reduction in the performance efficiency of the heating and/or cooling system and also reducing the possibility of possibly of total system failure.

The basket filter 560 is advantageously benefitted by providing an anti-microbial coating to prevent the growth of bacteria on the basket filter 560. This may advantageously reduce the potential for Microbially Influenced Corrosion (MIC), bacteria and biofilm growth within the heating and/or cooling system as well as reduce the potential for blockages and efficiency reductions due to the same.

FIG. 13 schematically shows another example of an apparatus 101 for treating a fluid. As per the fluid filter apparatuses described above, the fluid filter apparatus of FIG. 13 is likewise suitable for use in:
a) treating of new fluid (e.g., pre-treatment of initial fill fluid) introduced into a fluid circuit of a heating and/or cooling system via the apparatus, to fill the fluid circuit of the heating and/or cooling system. In this regard, advantageously, the apparatus may provide benefits with regards to improved filtering, not least in that filtering (and removal of: metallic, non-metallic, microbial matter and gasses such as oxygen) is able to be performed on the fill fluid prior to the fill fluid entering the fluid circuit of the heating and/or cooling system, thereby reducing corrosion, blockages and efficiency reductions of the heating and/or cooling system due to such debris and contamination in the fluid in the fluid circuit of the heating and/or cooling system; and
b) treatment of existing fluid of a fluid circuit of a heating and/or cooling system

The apparatus 101 is configured to treat fluid, such as water, initially when introduced into an empty fluid circuit via a temporary fluid connection 602 from a fluid supply connector 601. The apparatus 101 is also configured to treat existing fluid in a fluid circuit of a heating and/or cooling system.

The apparatus 101 comprises a vessel 102 having an open upper end 103 and a removable lid 108. The vessel includes a circulating fluid inlet port 104 in a side wall 105 thereof and a circulating fluid outlet port 106 and a combined drain and water inlet port 600 in a lower end 107 thereof.

The lid includes a dosing port 109 and an air vent port 110 and may be secured to the vessel by mechanical fixings 111.

A permanent magnet collector 112 is removably locatable within the vessel and is arranged to collect magnetic particles on an external collection surface 113 thereof. The collector may be arranged in the form of a grate or another suitable shape for collecting debris and comprise a plurality of housings, each containing a permanent magnet.

The vessel may be fabricated from stainless steel. The vessel may include brackets to mount the vessel to a wall. The vessel may house a removable filter 501 for collecting non-magnetic particles as well as bacteria on an external collection surface thereof. The vessel may also house a removable baffle plate 504.

The apparatus 101 of FIG. 13 may be installed and used to treat fluid in the manner and methods as described above.

The provision of a combined drain and water inlet port 600, located in the lower end 107 of the vessel 102 and moreover located upstream of the filter, advantageously may facilitate the draining of fluid from the vessel.

It is noted that, the circulating fluid outlet port 106 is located downstream of the filter 501. Accordingly, if the fluid were sought to be drained out of the vessel 102 via the circulating fluid outlet port 106, since the circulating fluid outlet port 106 is downstream of the filter 501, any fluid draining out of the vessel 102 via circulating fluid outlet port 106 must pass through the filter 501 prior to passing through and draining out of via the circulating fluid outlet port 106. Hence if the filter 501 were partially/fully blocked (e.g., with filtered: debris, dirt, detritus, microbes . . . ), this would impede/prevent the passage of fluid through the filter 501 and hence impede/prevent the passage of fluid through the circulating fluid outlet port 106 and therefore impede/prevent the draining of fluid from the vessel 102.

By contrast, in the fluid filter apparatus 101 of FIG. 13 (as well as the fluid filter apparatuses described with respect to FIGS. 1, 2 and 9-12) a combined drain and water inlet port 600 is provided which is located upstream of the filter 501. Accordingly, fluid may drain out of the vessel 102 via the combined drain and water inlet port 600 without needing to pass through the filter 501. Hence, even if the filter were partially/fully blocked, this would not impede/prevent the draining of fluid from the vessel 102 via the combined drain and water inlet port 600.

Although specific terms are employed herein, they are used in a generic and descriptive sense only and not for purposes of limitation.

Features described in the preceding description can be used in combinations other than the combinations explicitly described. For example, any of the different types of: fluid treatment apparatuses, vessels, magnetic collectors, filters and baffle plates can be combined together. For instance, the fluid treatment apparatus and vessel of FIG. 1 may be used with the combined baffle plate and permanent magnet collector of FIG. along with the filter basket of FIG. 8.

Although functions have been described with reference to certain features, those functions can be performable by other features whether described or not.

Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent.

Although various examples of the present disclosure have been described in the preceding paragraphs, it should be appreciated that modifications to the examples given can be made without departing from the scope of the invention as set out in the claims.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘connect’ and ‘couple’ and their derivatives mean operationally connected/coupled. It should be appreciated that any number or combination of intervening components can exist (including no intervening components), i.e., so as to provide direct or indirect connection/coupling.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1. An apparatus for treating fluid when initially introduced into an empty fluid circuit via a temporary fluid connection from a fluid supply connector, the apparatus also being suitable for treating existing fluid in a fluid circuit of a heating and/or cooling system, wherein the apparatus comprises a vessel comprising:
an open upper end,
a removable lid,
a circulating fluid inlet port in a side wall of the vessel,
a circulating fluid outlet port in a lower end of the vessel, and
a combined drain and water inlet port in the lower end of the vessel.

2. The apparatus of claim 1, wherein the removable lid includes a dosing port and an air vent port.

3. The apparatus of claim 1, wherein the removable lid is securable to the vessel by mechanical fixings.

4. The apparatus of claim 1, further comprising a permanent magnet collector removably locatable within the vessel; and optionally:
wherein the permanent magnet collector is arranged to collect magnetic particles on an external collection surface of the permanent magnet collector,
wherein the permanent magnet collector is arranged in the form of a grate or another suitable shape for collecting debris, and/or
wherein the permanent magnet collector comprises a plurality of housings each containing a permanent magnet.

5-7. (canceled)

8. The apparatus of claim 1, wherein the vessel comprises a bracket for mounting the vessel to a wall.

9. The apparatus of claim 1, wherein the vessel comprises a filter removably locatable within the vessel; and optionally:
wherein the removable filter is configured to collect non-magnetic particles on an external collection surface of the removable filter, and/or
wherein the removable filter is configured to collect bacteria on an external collection surface of the removable filter.

10. (canceled)

11. (canceled)

12. The apparatus of claim 1, wherein the vessel comprises a removable baffle plate.

13. The apparatus of claim 1, wherein the vessel comprises means for regulating a flow of fluid within the vessel, wherein means for regulating a flow of fluid within the vessel is removably locatable within the vessel.

14. The apparatus of claim 13, wherein the means for regulating the flow of fluid comprises:
at least one magnetic filtering means, and/or
at least one housing for housing at least one magnetic member.

15. (canceled)

16. The apparatus of claim 13, wherein the means for regulating the flow of fluid comprises at least one elongate shaft.

17. The apparatus of claim 16, wherein the at least one elongate shaft comprises a plurality of apertures along a length of the elongate shaft.

18. The apparatus of claim 16, wherein the elongate shaft is configured to be locatable within the circulating fluid outlet.

19. The apparatus of claim 16, wherein the vessel comprises filtering means comprising an aperture therethrough configured to receive the elongate shaft.

20. The apparatus of claim 1, wherein the vessel comprises means for removing dissolved solids from a fluid, wherein the means for removing dissolved metal is removably locatable within the vessel.

21. The apparatus of claim 20, wherein the means for removing dissolved solids comprises a container comprising a filter media configured to remove dissolved metal.

22. (canceled)

23. (canceled)

24. A side stream filter comprising the apparatus of claim 1.

25. A method of installing the apparatus of claim 1.

26. (canceled)

27. The method of claim 25, further comprising connecting the combined drain and water inlet port to a fluid supply via a temporary fluid connection.

28. The method of claim 25, further comprising filling the vessel with a fluid via the combined drain and water inlet port.
